(19) United States
(12) Patent Application Publication
(10) Pub. No.: US 2007/0177391 A1
(43) Pub. Date: Aug. 2, 2007

(54) LIGHTING FOR INSULATED GLAZING ASSEMBLY

(75) Inventors: Lee W. Davis, Holland, MI (US); Richard L. Horner, Grand Haven, MI (US); James D. Allardyce, Grandville, MI (US); Andrew R. Krochmal, Grand Haven, MI (US); Douglas F. Hutchings, Rockford, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: ODL, INCORPORATED, Zeeland, MI (US)

(21) Appl. No.: 11/621,827

(22) Filed: Jan. 10, 2007

Related U.S. Application Data
(60) Provisional application No. 60/758,975, filed on Jan. 12, 2006.

(51) Int. Cl. F21S 8/00

(52) U.S. Cl. 362/367; 362/145

(57) ABSTRACT

A lighted insulated glazing assembly including a light source. In a first aspect of the invention, the light source is within the insulated glazing assembly; and power is routed from the light source through the spacer assembly to a battery or wired power source located outside the assembly. In a second aspect of the invention, the light source is outside of the insulated glazing assembly. In both aspects, various light manipulators can be included to manipulate the light in order to create a desired lighting or visual effect.

### BACKGROUND OF THE INVENTION

The present invention relates to insulated glazing assemblies, and more particularly to a system for lighting an insulated glazing assembly.

Insulated glazing (“IG”) assemblies are well known. An IG assembly typically includes two panels separated with a spacer along the edge of the panels to create a hermetically sealed air space between the panels.

One system for lighting an IG assembly is taught in U.S. Pat. No. 7,043,881 to Krause. The Krause patent teaches the use of a single flexible spacer, such as a SWIGGLE® spacer, which is bent around the periphery of the glass panes with a portion of its ends overlapping to form a single joint. A series of lights are fixed within the assembly and powered by extending wires between the overlapping adhered ends of the spacer in order to maintain the hermetic seal of the IG assembly. Krause is unsatisfactory in some ways because of its inflexibility in configuration and arrangement of lights.

A decorative panel is sometimes mounted within an IG assembly in order to enhance the aesthetics of the assembly. The beauty of a decorative panel is often only observable if fully illuminated and it does not appear that Krause suggests or teaches how to light such a decorative panel. A decorative panel is often designed to interact with light in order to create an interesting and appealing appearance. The intricacies of a decorative panel are sometimes only fully appreciable if backlit by the sun, moon or an artificial light.

Natural light is often unreliable. Providing appropriate backlighting for the decorative panel requires positioning a light in proximity to the window. While somewhat effective, backlighting of the window requires that the light be positioned on one side of the window, thereby reducing the visibility of the decorative panel. Further, the placement of the source of the backlight may require the installation of lighting fixtures and wiring.

### SUMMARY OF THE INVENTION

The aforementioned problems are overcome in the present invention in which a lighting system illuminates an insulated glazing (“IG”) assembly. Optionally, the lighting may be configured to illuminate a decorative panel or other insert within the IG assembly.

In a first aspect of the invention, a light source is included within the IG assembly, and power is routed to the light source through the spacer assembly from a battery or wired power source located outside the IG assembly.

In a first embodiment, one or more light pipes are located within a U-channel spacer rail located proximal to an edge of the IG assembly—extending parallel to the edge. The light pipes may increase the intensity and direct light from the light source into the IG assembly. The light pipes may also provide structural stability to the IG assembly during manufacture or use. A light source, such as an LED, is located at one or both ends of the light pipe. Optionally, the LED may be mounted in a light pipe cap which interfaces the light pipe. Power for the light source is routed through the spacer assembly. For example, power may be routed from outside the IG assembly through a corner key or spacer rail of the spacer assembly to the LED located inside the IG assembly. A sealant is used on the exterior of the spacer assembly to enclose or hermetically seal the spacer assembly, light, light pipe, and optional decorative panel between the pair of glazing panels.

A second embodiment positions one or more light sources along the spacer assembly without the assistance of a light pipe. For example, light sources may be mounted along a U-channel spacer, in conjunction with a reflector and lens, or at the edge of a decorative panel.

A third embodiment positions a light source or light manipulator on a retractable shade or louver system mounted inside the IG assembly. The light source may be manipulated in various ways by retracting the shade or rotating the louvers. In powered retractable shade and louver system embodiments, power may be provided simultaneously to both the retractable shade or louver system and the light source through the spacer assembly.

A fourth embodiment features a light source directly mounted to a panel or mounted to a caming or mullion within the IG assembly. The light source may be mounted in a variety of configurations depending on the desired lighting and type of light source.

A fifth embodiment features a light manipulator directly mounted to a panel or mounted to a caming or mullion within the IG assembly. The light source may be mounted essentially anywhere in the IG assembly. The light guides may be arranged to create essentially any desired lighting pattern or effect.

In a second aspect of the invention, one or more light sources are external to the IG assembly and flood or route light through the IG assembly. For example, the internal lighting embodiments discussed above have corollary external lighting embodiments to achieve a similar lighting effect either by flooding or piping in light to be manipulated using light guides, lenses, reflectors, or other light manipulators.

These and other objects, advantages and features of the invention will be more readily understood and appreciated by reference to the description of the current embodiments and the drawings.

### BRIEF DESCRIPTION OF THE DRAWINGS

FIG. 1 is a perspective view of one embodiment of a lighted IG assembly installed within a frame embodying the present invention.

FIG. 2A is a front plan view of the lighted IG assembly of FIG. 1.

FIG. 2B is an enlarged exploded view of section I of the lighted IG assembly shown in FIG. 2A.

FIG. 3 is a sectional view of the lighted IG assembly taken along line A-A of FIG. 2A.

FIG. 4 is a sectional view of one embodiment of a lighted IG assembly using a light pipe.

FIG. 5 is a sectional view of one embodiment of a lighted IG assembly using a U-channel spacer.

FIG. 6 is a sectional view of one embodiment of a lighted IG assembly using a reflector and lens.

FIG. 7 is a sectional view of one embodiment of a lighted IG assembly using an edge light.

FIG. 8A is a sectional view of one embodiment of a lighted IG assembly using an internal retractable shade.

FIG. 8B is a sectional view of one embodiment of a lighted IG assembly using an internal louver system.

FIG. 9A is a sectional view of one embodiment of a lighted IG assembly using an internal caming.

FIG. 9B is a sectional view of one embodiment of a lighted IG assembly using an internal mullion.

FIG. 10A is a sectional view of one embodiment of a lighted IG assembly using a light guide and internal caming.

FIG. 10B is a sectional view of one embodiment of a lighted IG assembly using a light guide and an internal mullion.

FIG. 10C is a sectional view of a lighted IG assembly of FIG. 10A or FIG. 10B using a light source to direct light towards a light guide.

FIG. 11A is a sectional view of one embodiment of a lighted IG assembly using fiber optic wire.

FIG. 11B is a sectional view of one embodiment of a lighted IG assembly using fiber optic wire and a concealed light source.

FIG. 12 is a sectional view of one embodiment of a lighted IG assembly using a light source and a clear trace.

FIG. 13 is a sectional view of one embodiment of a lighted IG assembly using a light source and a corner caming module.

FIG. 14 is a sectional view of one embodiment of a lighted IG assembly using a plastic light guide.

FIG. 15 is a sectional view of one embodiment of a lighted IG assembly using a glass light guide.

FIG. 16 is a front view of the lighted IG assembly of FIG. 14 or FIG. 15 showing a lighting pattern.

FIG. 17 is a sectional view of one embodiment of a lighted IG assembly using a panel with a UV coating.

FIG. 18A is a sectional view of one embodiment of an externally lighted IG assembly using an add-on panel.

FIG. 18B is a sectional view of the externally lighted IG assembly of FIG. 18A showing how the add-on panel attaches.

FIG. 19 is a sectional view of one embodiment of an externally lighted IG assembly using a pop-out light source.

FIG. 20 is a sectional view of one embodiment of an externally lighted IG assembly using a lens and light source mounted within the frame.

FIG. 21 is a sectional view of one embodiment of an externally lighted IG assembly using a light guide.

FIG. 22 is a sectional view of one embodiment of an externally lighted IG assembly using a reflector.

FIG. 23 is a sectional view of one embodiment of an externally lighted IG assembly using a light source mounted to the unit.

FIG. 24 is a sectional view of one embodiment of an externally lighted IG assembly using an external overlay.

FIG. 25 is a sectional view of one embodiment of an externally lighted IG assembly using an external retractable shade.

FIG. 26 is a sectional view one embodiment of an externally lighted IG assembly using a light source contained within a frame enclosing the unit.

### DESCRIPTION OF THE CURRENT EMBODIMENTS

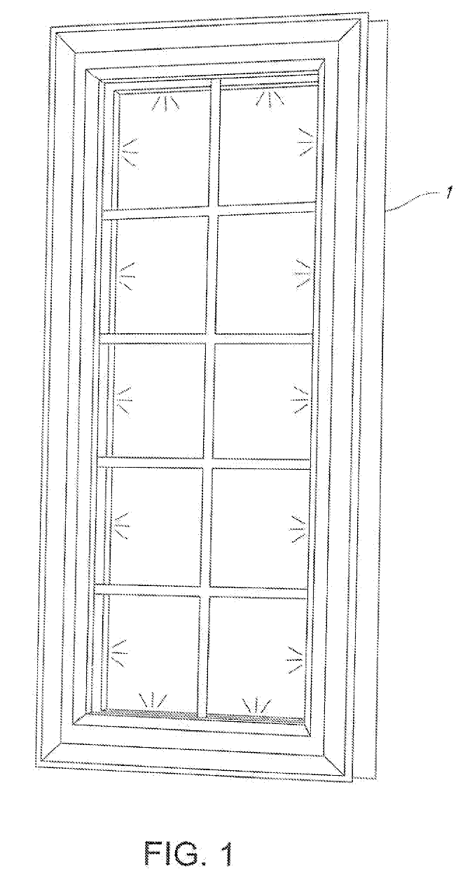

A lighted insulated glazing (“IG”) assembly constructed in accordance with the current embodiment of the invention is illustrated in FIGS. 1-3 and generally designated 1. The IG assembly 1 generally includes a first glazing panel 10 and a second glazing panel 12 separated by a closure 14 with a light source 60 mounted within. In the current embodiment, the closure 14 includes a spacer assembly 200 (spacer rails 22, 24, 26, 28 and corner keys 30, 32, 34, 36) and sealant 106. Although each spacer rail of the current embodiment includes a closed spacer 100, a surround or mounting spacer 102, and a U-channel spacer 104, in other embodiments the spacer rails may include different combinations, amounts, and types of spacers. Polysulfide is an exemplary sealant used in the current embodiment, although essentially any suitable sealant may be used to create a hermetic or substantially hermetic seal. Other means for spacing and sealing the assembly could be used as well.

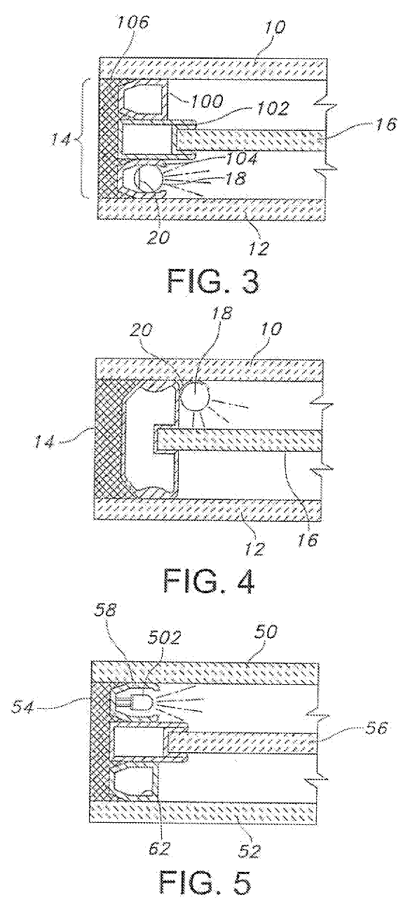

In the current embodiment, and optionally in alternative embodiments, a decorative or intermediate panel 16 is mounted within the surround 102 of closure 14, perhaps as best shown in FIG. 3. Mounting decorative panels or inserts within IG assemblies is known and essentially any mounting technique may be used in accordance with the present invention, including those which do not utilize a surround.

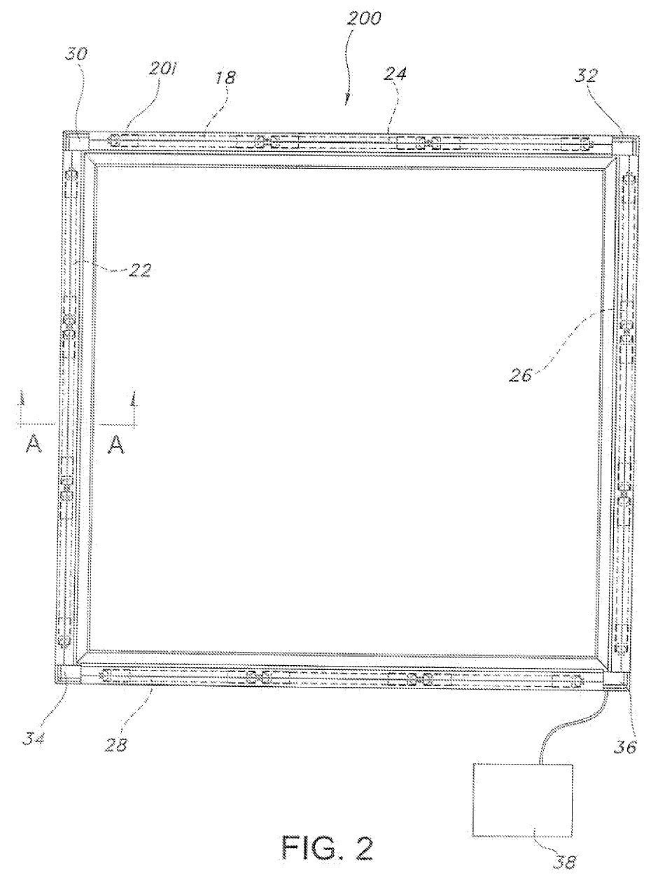

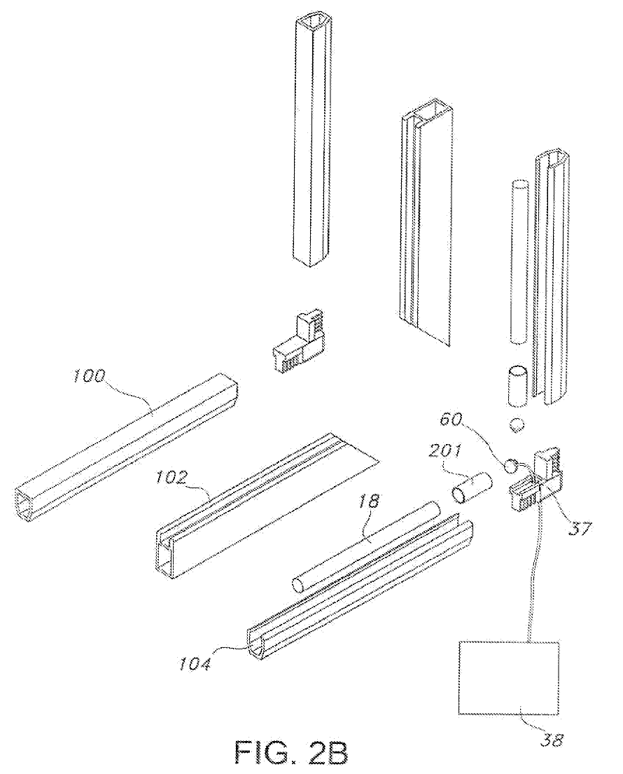

In one embodiment, the spacer rails 22, 24, 26, 28 and corner keys 30, 32, 34, 36 cooperate to help form a spacer assembly 200, which when combined with sealant 106 forms closure 14, as shown in FIG. 2A. A known spacer assembly utilizing spacer rails and corner keys is described in U.S. Pat. No. 6,601,633 to Sun and is herein incorporated by reference. In the current embodiment, pairs of corner keys 30, 32, 34, 36 are provided that are adapted to interfit each of the spacers of the spacer rails 22, 24, 26, 28 terminating at each corner. One or more of the corner keys may be penetrated to route power from outside the IG assembly to inside the IG assembly. In alternative embodiments, additional or fewer corner keys may be implemented, depending on the desired design of the spacer assembly.

In the current embodiment, each end of a light pipe 18 interfaces a light pipe cap 201, as shown in FIG. 2B. Each cap 201 may be configured to interfit and cooperate with the light pipe 18, which will be discussed in more detail below, such that light may be directed or optically coupled from the light source 60 into the light pipe 18. Light caps in alternative embodiments may be configured differently. Each cap 201 in the current embodiment, has a light source 60 mounted within the cap 201, as shown in FIG. 2B. The light source 60 could be an incandescent lamp, light emitting diode (“LED”), electroluminescent lamp, cold cathode, fiber optic light, fluorescent lamp, light guide or any other suitable light source. Although a light source 60 is located near the end of each light pipe 18 in the current embodiment, light sources could be positioned at additional, fewer or different locations with or without light pipe caps. For example, light sources could be positioned only near each of the corner keys or mounted directly to the spacer assembly. Alternatively, a light source could be inserted within the light pipes at various locations.

Power to the light source inside the IG assembly may be provided through the spacer assembly 200. In the current embodiment, power is routed from a power source 38 located outside the IG assembly through an opening 37 in one of the corner keys 36. The opening 37 may be sealed, for example with polysulfide, to maintain a hermetic or substantially hermetic seal. Once power is provided inside the IG assembly it may be distributed among the various light sources. For example, wires may be run along the inside of the spacer assembly connecting each light source in series. Power may be provided through additional corner keys and from additional power sources if desired. In alternative embodiments, power may be routed through one or more of the spacer rails. In another embodiment, a power interface is provided in the spacer assembly to facilitate the routing of power to the inside of the IG assembly. In one embodiment, two female terminals are provided in a corner key and wired to provide power to a light source inside the IG assembly. The female terminals may interface with a pair of male power connectors to provide power from a power source. In one embodiment, polysulfide covers the female terminals and the male power connectors are inserted into the female terminals through the polysulfide so as to maintain the IG assembly seal.

In the current embodiment, multiple light pipes 18 are disposed longitudinally within each of the U-channel spacers 104 in the four spacer rails 22, 24, 26, 28. Additional or fewer light pipes 18 may be employed to achieve a desired lighting effect. For example, in one alternative embodiment, a single light pipe could be formed to fit around the perimeter of the spacer assembly 200 or a single light pipe could be mounted to each spacer rail 22, 24, 26, 28. Depending upon the desired light effect, different configurations for the position and orientation of light pipes may be satisfactory. For example, in another alternative embodiment, light pipes are only installed in spacer rails 22, 26. Light pipes and light sources could also be positioned on either side of panel 16. Light sources 60 could be white, amber, green or any other color or color combination. An optional reflector, light guide, lens, or other light manipulator may be used in conjunction with each light pipe 18 to increase the intensity, direct, or otherwise manipulate the light projected. In the current embodiment, a white reflective coating 20 is affixed to a portion of each light pipe 18 in order to reflect light from the light pipes 18 into the IG assembly. In the current embodiment, the coating 20 and light pipe 18 are configured to reflect light onto the decorative panel 16 to achieve a desired lighting effect.

In addition, the light pipes 18 may also provide structural stability to the IG assembly 1 during manufacture or use. The use of a U-channel spacer could potentially be problematic during manufacture of the IG assembly. During manufacture, in some embodiments depending on the sealant method, the IG assembly may be subject to certain compression forces. For example, in a dynamic sealant method, the IG assembly, upon initial construction, may be run through a set of rollers in order to form a hermetic, or substantially hermetic, seal. In a static sealant method, weight may be placed on the IG assembly in order to form a hermetic, or substantially hermetic, seal. Accordingly, during manufacture, the IG may be subject to a certain amount of compression force that needs to be withstood. The light pipes 18 may assist in withstanding these forces.

In alternative embodiments, the U-channel spacers may be deleted altogether and replaced or augmented with reflectors, light guides, lenses, or other light manipulators that may be used to achieve a desired lighting effect. FIG. 4 shows an alternative embodiment of an IG assembly with a light pipe but no U-channel spacer. These alternative embodiments are merely exemplary, not exhaustive. A person of ordinary skill in the art would understand how to implement other possible variations.

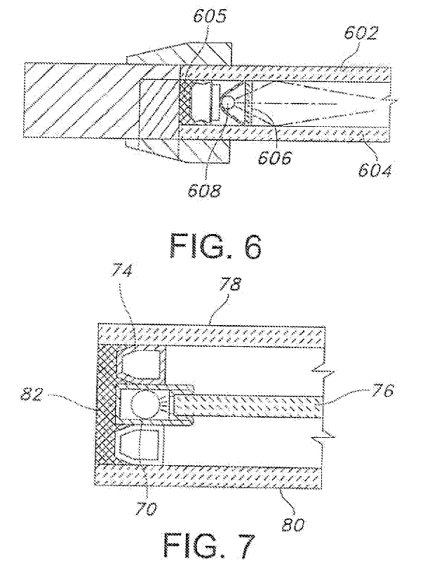

A second embodiment of the lighted IG assembly positions one or more light sources along the spacer assembly without the help of a light pipe. For example, within a U-channel spacer as shown in FIG. 5, in conjunction with a reflector and lens as shown in FIG. 6 or at the edge of a decorative panel as shown in FIG. 7—each of which are discussed in more detail below. As in the first embodiment, power is routed from outside the IG assembly 1 through the spacer assembly 200. Variations of this second embodiment are shown in FIGS. 5-7 and described below in more detail.

The U-channel spacer embodiment shown in FIG. 5 includes an IG assembly with a first glazing panel 50 and a second glazing panel 52 spaced apart by a spacer assembly including U-channel spacer 58, decorative panel 56, and spacer 62. Panel 56 is mounted inside the IG assembly by the U-channel spacer 58 and spacer 62. A light source 502 is mounted within the U-channel spacer 58. The light source may be an LED, an incandescent lamp, electroluminescent lamp, cold cathode, fiber optic light, fluorescent lamp, light guide, or essentially any other suitable source of light. The light source may be augmented with reflectors, light guides, lenses, or other light manipulators to achieve a desired lighting effect. Sealant 54 is used on the exterior of the spacer assembly to enclose or hermetically seal the panel 56, U-channel spacer 58, light 502, and spacer 62 between the pair of glazing panels. The U-channel assists in directing the light from the light source towards the interior of the IG assembly.

The reflector and lens embodiment shown in FIG. 6 includes an IG assembly with a first glazing panel 602 and a second glazing panel 604 spaced apart by a closure 605. A light source 608 is mounted inside the IG assembly to the closure 605 which seals off the IG assembly. The light source may be an LED, an incandescent lamp, electroluminescent lamp, cold cathode, fiber optic light, fluorescent lamp, light guide, or essentially any other suitable source of light. A reflector is mounted between the light source and the seal in order to reflect light towards the interior of the IG assembly. The light source may be augmented with additional reflectors, light guides, additional lenses, or other light manipulators to achieve a desired lighting effect.

The decorative panel edge light embodiment shown in FIG. 7 includes a spacer 74 that separates the pair of glazing panels of an IG assembly. A channel 72 within the spacer is provided to mount the decorative panel 76. The light source 70 is mounted within the channel 72 at the edge of the decorative panel 76 so as to project light into the decorative panel 76. The light source may be an LED, an incandescent lamp, electroluminescent lamp, cold cathode, fiber optic light, fluorescent lamp, light guide, or essentially any other suitable source of light. The light source 70 may be augmented with reflectors, light guides, lenses, or other light manipulators to achieve a desired lighting effect. A sealant 82 is used on the exterior of the spacer 74 to enclose or hermetically seal the panel, spacer assembly, and light between the pair of glazing panels.

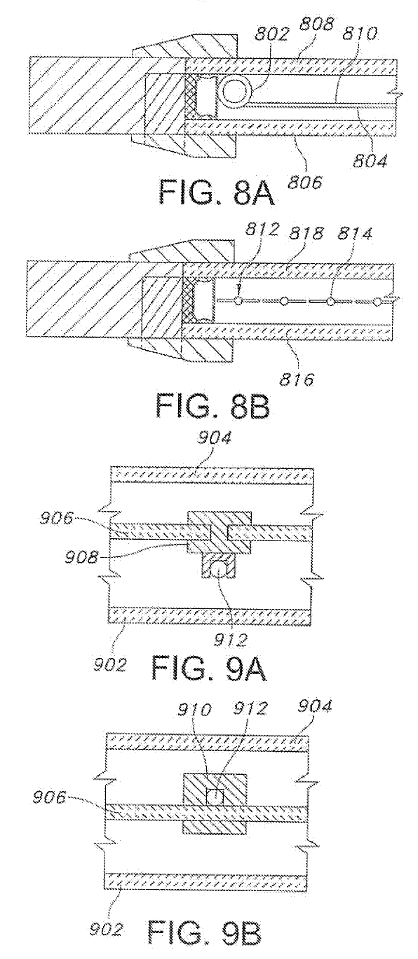

A third embodiment positions a light source or light guide on a retractable shade system, as shown in FIG. 8A, or louver system, as shown in FIG. 8B, mounted inside the IG assembly—each of which are described in more detail below.

In the retractable shade embodiment shown in FIG. 8A a retractable shade 802 is installed within an IG assembly using known techniques for installing a retractable shade. The retractable shade system 802 includes a light source 804 which directs light substantially in one direction such that panel 806 of the IG assembly is lit and panel 808 of the IG assembly is unlit and blocked by the substantially opaque shade 810. The light source 804 may be an electroluminescence (“EL”) panel, EL strip, or essentially any other suitable light source. In one embodiment, an EL panel is laminated to and covers the full shade 810. Power may be provided to the light source 804 through the spacer assembly as described above. In one embodiment, power to the light source 804 may be provided simultaneously with power to the retractable shade system 802.

In the louver system embodiment shown in FIG. 8B a louver system 812 is installed within an IG assembly using known techniques for installing a louver system. The louver system 812 includes a light source 814 which directs light in substantially one direction, the direction depending on how the louvers are oriented. Panel 816 of the IG assembly is lit and panel 818 of the IG assembly is unlit when the louvers are oriented in a first position; panel 816 of the IG assembly is unlit and panel 818 is lit when oriented in a second position; and neither panel is lit when the louvers are oriented in a third position—instead natural light is allowed to pass through the IG assembly. The light source 814 may be an electroluminescence (“EL”) panel, EL strip, or essentially any other suitable light source. In one embodiment, an EL panel is laminated to each clear louver of the louver system. Power may be provided to the light source 814 through the spacer assembly as described above. In one embodiment, power to the light source 814 may be provided simultaneously with power to the louver system. In one variation on this embodiment, light guides are attached to the front and/or back of each louver instead of a light source and a light source instead is mounted to the side of each louver to provide light for the light guides.

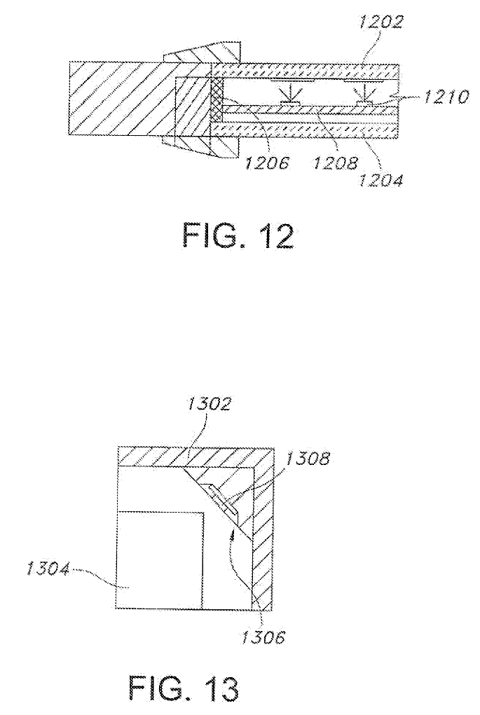

A fourth embodiment features a light source mounted to a panel within the IG assembly. For example, an EL source mounted to a caming or mullion as shown in FIGS. 9A and 9B, a light source directly mounted to a panel as shown in FIG. 12, a light source corner mounted to a caming as shown in FIG. 13—each of which are discussed in more detail below.

The EL source embodiments shown in FIGS. 9A and 9B include an IG assembly with a first panel 902, a second panel 904, and an intermediate panel 906 mounted between. The intermediate panel 906 includes either a caming 908, shown in FIG. 9A or a mullion 910, shown in FIG. 9B. An EL source 912, such as a wire or strip, is mounted using the caming 908 or mullion 910. The EL source 912 may be augmented with reflectors, light guides, lenses, or other light manipulators to achieve a desired lighting effect. Optionally, the EL source 912 may be hidden behind an etched or textured pattern. Power may be provided to the EL source through the spacer assembly as described above.

The direct mount embodiment shown in FIG. 12 includes an IG assembly with a first panel 1202 and, a second panel 1204 separated and sealed by a closure 1206. Intermediate panel 1208 is mounted inside the IG assembly. One or more light sources 1210 are mounted on the intermediate panel 1208 using adhesive or other techniques known in the art. Alternatively, the light source 1210 could be mounted on one of the IG assembly panels. The light source 1210 could be an LED or any other suitable light source. The light source 1210 may be augmented with reflectors, light guides, lenses, or other light manipulators to achieve a desired lighting effect. Optionally, the light source 1210 may be hidden behind an etched or textured pattern. Power may be provided to the light source 1210 through the spacer assembly as described above. In one embodiment, power may be provided to the light source 1210 using clear traces.

The corner mounted embodiment shown in FIG. 13 includes an IG assembly with caming 1302 mounted to a decorative glass panel or set of decorative panels 1304 mounted within the IG assembly. A corner module 1306 is mounted to or integrally formed with the caming 1302 to provide a suitable orientation for a light source 1308. Light source 1308 is mounted to the corner module 1306. The light source 1308 could be an LED or any other suitable light source. The light source 1308 may be augmented with reflectors, light guides, lenses, or other light manipulators to achieve a desired lighting effect. Optionally, the light source 1308 may be sealed inside the corner module. A light source may be located at each panel corner and may selectively light certain panels from selected corners. Power may be provided to the light source 1308 by wiring through the caming or along the panel 1304 and through the spacer assembly as described above.

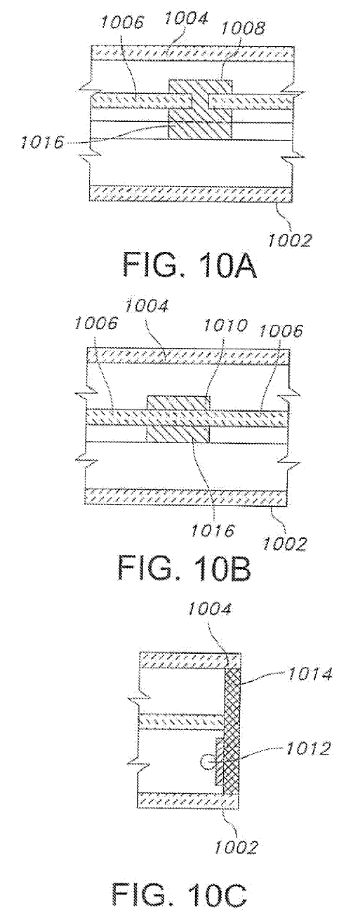

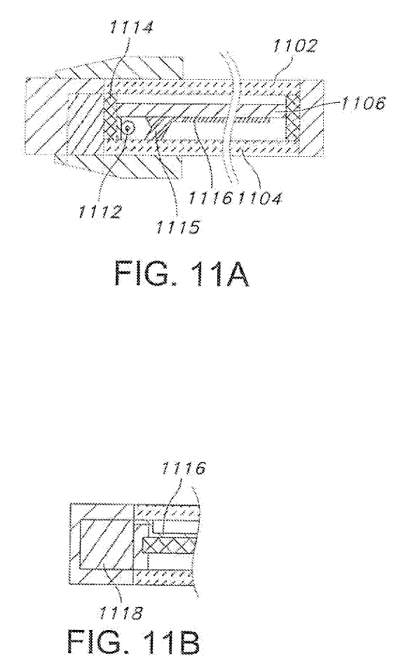

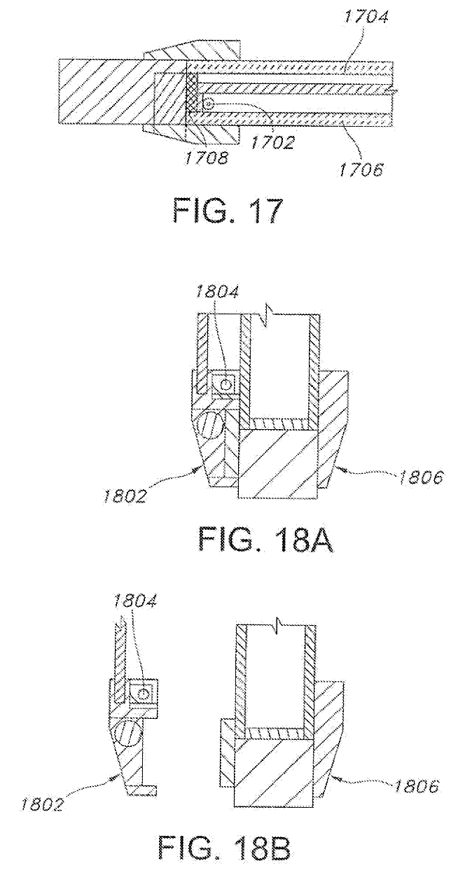

A fifth embodiment features a light manipulator mounted to a panel within the IG assembly. For example, a light guide mounted to a caming or mullion as shown in FIGS. 10A, 10B, and 10C, a fiber optic wire mounted to a panel as shown in FIGS. 11A and 11B, or a ultraviolet (“UV”) coating as shown in FIG. 17—each of which are discussed in more detail below. In these light manipulator embodiments the light source may be mounted in a variety of configurations and positions depending on the desired lighting and type of light source.

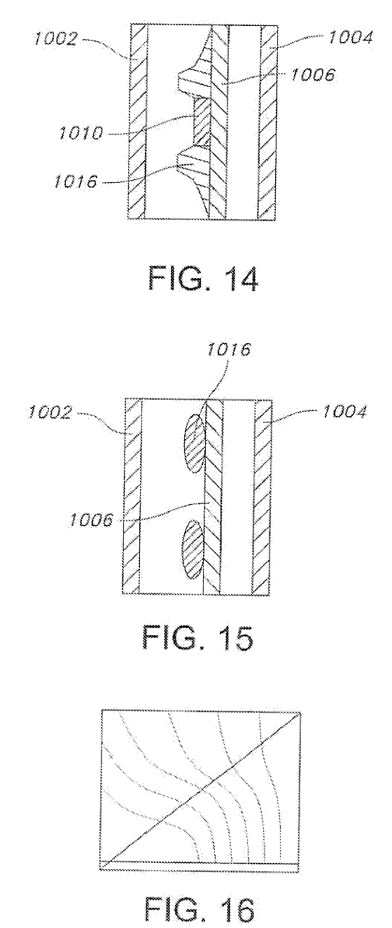

The light guide embodiments shown in FIGS. 10A, 10B, and 10C include an IG assembly with a first panel 1002, a second panel 1004, and an intermediate panel 1006 mounted between. One or more light sources 1012 are mounted to the closure 1014. One or more light guides 1016 are mounted to the caming 1008, shown in FIG. 10A, mullion 1010, shown in FIG. 14, or panel 1006, shown in FIG. 10B and FIG. 15. The light guides 1016 may be plastic, glass, or any other suitable material. The light guides may be arranged and oriented to create essentially any desired lighting effect. An exemplary lighting effect is shown in FIG. 16. The light source 1012 is mounted to the closure 1014 at light guide end points, so as to direct light into the light guide 1016. The light guide 1016 or light source 1012 may be augmented with reflectors, additional light guides, lenses, or other light manipulators to achieve a desired lighting effect. Optionally, the light source 1012 may be hidden behind an etched or textured pattern. Power may be provided to the light source through the spacer assembly as described above.

The fiber optic embodiments shown in FIGS. 11A and 11B include an IG assembly with a first panel 1102, a second panel 1104, and an intermediate panel 1106 mounted between. The light source 1112 is mounted to closure 1114. Light guide 1115 guides light into the fiber optic wire 1116 which is mounted to intermediate panel 1106. Power may be provided to the light source 1112 through the spacer assembly as described above. In an alternative embodiment, the fiber optic wire 1116 is snaked through the closure 1114 to a concealed light source 1118.

The UV coating embodiment shown in FIG. 17 features a lighted IG assembly with fluorescent coated panels. One or more ultraviolet light sources 1702 mounted to the closure 1708 may flood the IG assembly to provide a desired lighting effect. The fluorescent coated panels 1704, 1706 may highlight etched or textured sections, highlight caming, create glow, or control fluorescent color. The coating may also eliminate exposure of plastic parts to the UV source 1702. Power may be provided to the light source through the spacer assembly as described above.

Various combinations and alterations of the above described embodiments would be understood by one skilled in the art. It should be understood that any of the above embodiments may be combined with one or more of the other embodiments. For example, a person skilled in the art would understand how a light pipe (first embodiment), a light source on a spacer (second embodiment), a lighted retractable shade or lighted louver system (third embodiment), a light source mounted on a panel (fourth embodiment), a light manipulator on a panel (fifth embodiment), and any combination thereof could be combined in the same IG assembly.

In a second aspect of the invention, one or more light sources are installed external to the IG assembly and flood or route light through the IG assembly. Many of the internal lighting embodiments discussed above have a corollary external lighting embodiment to achieve a similar lighting effect either by flooding or piping in light to be manipulated using light guides, lenses, reflectors, or other light manipulators. Examples of such external embodiments can be seen in FIGS. 18-26 and are briefly discussed below. It should also be understood that a person skilled in the art would understand how to combine the internal lighting embodiments discussed above with the external lighting embodiments described below in a single IG assembly.

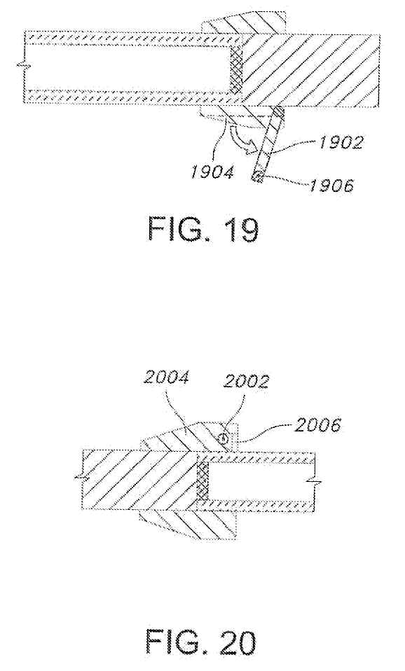

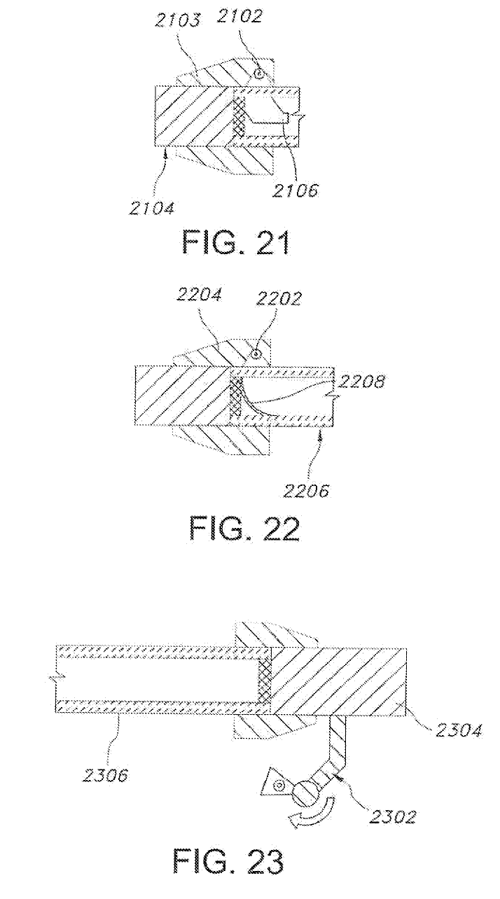

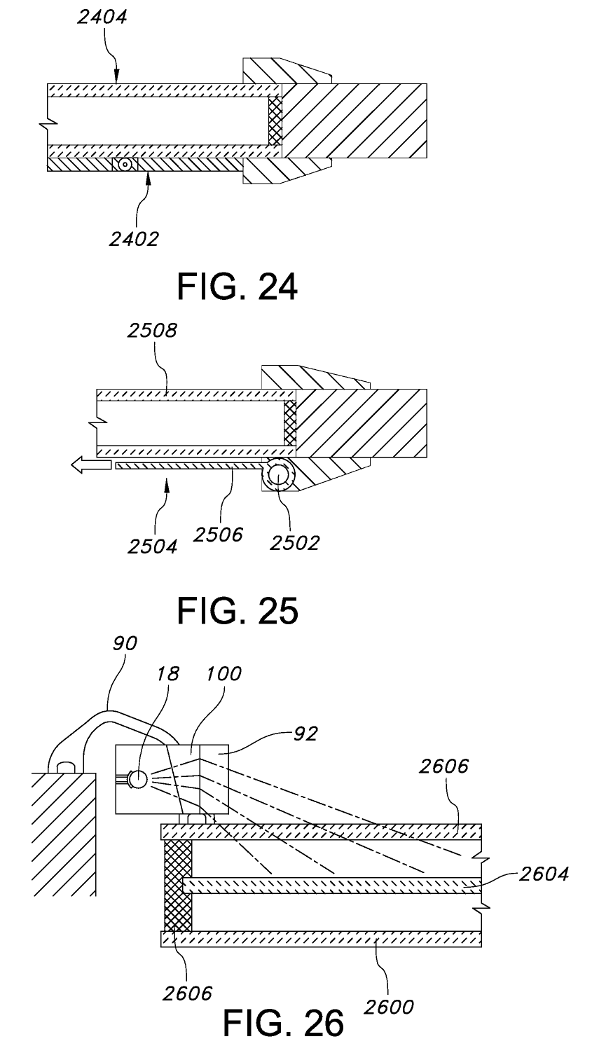

FIG. 18A shows an add-on panel 1802 that includes a light source 1804 which may be used to light the IG assembly 1806. FIG. 18B shows how the add-on panel 1802 attaches to the IG assembly 1806. FIG. 19 shows an external pop-out 1902 that pops out from the frame 1904 and directs light from a light source 1906 through the IG assembly. FIG. 20 shows an external light source 2002 that is mounted within a modified frame 2004. A lens 2006 helps direct light into the IG assembly and produce a halo effect. FIGS. 21 shows a concealed external light source 2102 that is mounted within the frame 2103. Light is directed inside the IG assembly 2104 and through a light guide 2106 to give the appearance that the IG assembly 2104 is being lit internally. FIG. 22 shows a concealed external light source 2202 that is mounted within the frame 2204. Light is directed inside the IG assembly 2206 and onto a reflector 2208 to give the appearance that the IG assembly 2206 is being lit internally. FIG. 23 shows an external lamp 2302 mounted to a door or window 2304 that directs light into the IG assembly 2306. FIG. 24 shows an external light source overlay 2402 which directs light into the IG assembly 2404. FIG. 25 shows an external retractable shade 2502 with an EL panel 2504 laminating a decorative shade 2506 that directs light into the IG assembly 2508.

FIG. 26 shows another arrangement for an external IG assembly. Pane 2602, pane 2600, closure 2606 and panel 2604 form an IG assembly with an insert. Closure 2606 could include a pair of spacers with panel 2604 held between the spacers with a sealant used to close the assembly.

Frame 90 includes light projector 92. Light projector 92 illuminates panel 2604 as well as glass pane 2602. Light projector 92 includes light source 98 and lens 100. Lens 100 directs light from lamp 98 onto panel 2604 and glass pane 2602. The light source 98 could be, for example, an incandescent lamp, a fluorescent lamp, an LED, an electroluminescent lamp, or a light pipe optically coupled to a light source.

The above descriptions are those of the current embodiments. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A lighted insulated glazing assembly comprising:
a pair of glazing panels;
a spacer assembly adhered to and separating said pair of glazing panels to form a substantially sealed air space between said pair of glazing panels;
a light source disposed within said air space wherein power for said light source penetrates and is routed through said spacer assembly, such that said substantially sealed air space between said pair of glazing panels is maintained.

2. The lighted insulated glazing assembly of claim 1 wherein said spacer assembly comprises a corner key, wherein said corner key defines an opening and wherein power for said light source is routed through said corner key opening such that said substantially sealed air space between said pair of glazing panels is maintained.

3. The lighted insulated glazing assembly of claim 1 wherein said spacer assembly comprises a power interface, wherein power for said light source is routed through said power interface.

4. The lighted insulated glazing assembly of claim 1 wherein said spacer assembly comprises a U-channel spacer, wherein a light pipe is mounted within said U-channel spacer.

5. The lighted insulated glazing assembly of claim 4 wherein said spacer assembly comprises further comprises a corner key and a cap, wherein said light source is mounted in said cap and said cap interfits with said light pipe, wherein power for said light source is routed through said corner key and said cap.

6. The lighted insulated glazing assembly of claim 1 wherein said light source comprises an electroluminescence source disposed on a retractable shade or louver.

7. The lighted insulated glazing assembly of claim 1 further comprising a light guide disposed on a retractable shade or louver.

8. The lighted insulated glazing assembly of claim 1 wherein said light source is disposed on a caming or mullion.

9. The lighted insulated glazing assembly of claim 1 further comprising a lens and reflector for directing light from said light source.

10. The lighted insulated glazing assembly of claim 1 further comprising a fiber optic wire in communication with said light source.

11. The lighted insulated glazing assembly of claim 1 wherein said light source is disposed on a decorative panel mounted within said insulated glazing assembly and powered using a clear trace.

12. The lighted insulated glazing assembly of claim 1 further comprising an ultraviolet reflective coating covering at least a portion of said glazing panels.

13. A lighted insulated glazing assembly comprising:
a pair of glazing panels;
a spacer assembly comprising a plurality of spacers and a plurality of corner keys adhered to and separating said pair of glazing panels to form a sealed air space between said pair of glazing panels;
a light pipe mounted to said spacer assembly with two ends;
a cap, wherein said cap is interfit with one of said light pipe ends; and
a light source mounted within said cap, wherein power for said light source is routed from outside said IG assembly through said corner key and said cap.

14. The lighted insulated glazing assembly of claim 13 wherein said light source is augmented with at least one of a reflector, a light guide, a lens, a light manipulator, or any combination thereof.

15. A lighted insulated glazing assembly comprising:
a pair of glazing panels;
a spacer assembly adhered to and separating said pair of glazing panels to form a sealed air space between said pair of glazing panels;
an intermediate insert mounted within said sealed air space;
a light manipulator or light source mounted to said intermediate insert adapted to receive light from said light source.

16. The lighted insulated glazing assembly of claim 15 wherein said intermediate insert comprises a retractable shade or louver system.

17. The lighted insulated glazing assembly of claim 15 wherein said intermediate insert comprises a decorative panel.

18. The lighted insulated glazing assembly of claim 17 wherein said decorative panel further comprises caming, wherein said light manipulator or light source is mounted to a corner of said caming.

19. A lighted insulated glazing assembly comprising:
a pair of glazing panels;
a spacer adhered to and separating said pair of glazing panels to form a space between said pair of glazing panels, said spacer defining an opening facing said space;
a light source within said spacer and adapted to direct light through said opening and into said space.

20. A lighted insulated glazing assembly comprising:
a pair of glazing panels;
a spacer assembly separating said pair of glazing panels to form a space between said pair of glazing panels;
a light source supported by said spacer assembly; and
a light pipe within said space, said light pipe having an end optically coupled to said light source.

21. A lighted insulated glazing assembly comprising:
a pair of glazing panels;
a spacer assembly adhered to and separating said pair of glazing panels to form a space between said pair of glazing panels;
an intermediate panel mounted within said sealed air space;
a light source mounted to said intermediate panel.
